(19) United States
(12) Patent Application Publication
(10) Pub. No.: US 2012/0207957 A1
(43) Pub. Date: Aug. 16, 2012

(54) Fabric Reinforced Rubber Article Having Pattern Coated Reinforcement Fabric

(76) Inventors: Dany F. Michiels, Haaltert (BE); Joseph R. Royer, Simpsonville, SC (US)

(21) Appl. No.: 13/027,496

(22) Filed: Feb. 15, 2011

(51) Int. Cl. B32B 25/10; B32B 3/10; B32B 7/12; B32B 1/08; B32B 25/08

(52) U.S. Cl. 428/36.1; 428/196; 428/197; 442/66

(57) ABSTRACT

A fabric reinforced rubber article containing at least one layer of a pattern coated reinforcement fabric embedded in rubber. The pattern coated reinforcement fabric contains a fabric base having a first and second side and is a woven, knit, or nonwoven. The fabric base has an adhesion layer on both the first and second side of the fabric and a patterned coating of a tackifing material on at least the first side of the fabric overlaying a portion of the adhesion layer. The fabric reinforced rubber article may be any suitable rubber article including tires and hoses.

### TECHNICAL FIELD

The present invention generally relates to reinforced rubber articles containing fabrics with a patterned coating of a tackifing material.

### BACKGROUND

Technical difficulties have been encountered in incorporating fabrics into the rubber goods that need reinforcement. One of the difficulties lies in ensuring good adhesion between the natural or synthetic yarns and the rubber.

In tires, the centrifugal force of the steel belts can cause difficulty in the adhesion of the belt within the tire. One solution has been to coat the fabrics with a tackifing material.

While tackifing chemistries decrease the delamination between fabrics and the rubber and help with tack during manufacturing, too much of the tackifing chemistry could possibly have deleterious effects on the final product. Thus, it is desirable to reduce the amount of tackifing in rubber reinforced goods such as tires and hoses while maintaining enough tack for manufacture.

### BRIEF SUMMARY

A fabric reinforced rubber article containing at least one layer of a pattern coated reinforcement fabric embedded in rubber. The pattern coated reinforcement fabric contains a fabric base having a first and second side and is a woven, knit, or nonwoven. The fabric base has an adhesion layer on both the first and second side of the fabric and a patterned coating of a tackifing material on at least the first side of the fabric overlaying a portion of the adhesion layer. The fabric reinforced rubber article may be any suitable rubber article including tires and hoses.

### BRIEF DESCRIPTION OF THE FIGURES

An embodiment of the present invention will now be described by way of example, with reference to the accompanying drawings.

FIG. 1A is a cutaway partial view of a pneumatic radial tire having one cap ply strip wrapped around the carcass;

FIG. 1B is a cutaway partial view of a pneumatic radial tire having two cap ply strips wrapped around the carcass;

FIG. 1C is a cutaway partial view of a pneumatic radial tire having a cap ply strip wrapped helically;

FIG. 2 is a cross-sectional view corresponding to FIG. 1a;

FIG. 3 is a cutaway partial view of a fabric reinforced hose illustrating one embodiment of the invention;

FIG. 4 is a cross-sectional view of a fabric reinforced hose;

FIG. 5 is a schematic of a top view of a pattern coated reinforcement fabric having a discontinuous dot pattern of tackifing material on surface of the fabric over the adhesion layer;

FIG. 6 is a schematic of a top view of a pattern coated reinforcement fabric having a discontinuous pattern of random areas of tackifing material on surface of the fabric over the adhesion layer;

FIG. 7 is a schematic of a top view of a pattern coated reinforcement fabric having a grid pattern of tackifing material on surface of the fabric over the adhesion layer;

FIG. 8 is a schematic of a top view of a pattern coated reinforcement fabric having pattern of a series of parallel lines of tackifing material on surface of the fabric over the adhesion layer;

FIG. 9A is a schematic of a side view of a pattern coated reinforcement fabric showing the discontinuous pattern of tackifing material on surface of the fabric over the adhesion layer;

FIG. 9B is a schematic of a side view of a pattern coated reinforcement fabric showing the discontinuous pattern of tackifing material on surface of the fabric over the adhesion layer;

FIG. 10 is a schematic of a side view of a pattern coated reinforcement fabric showing the discontinuous pattern of tackifing material on surface of the fabric over the adhesion layer, where the pattern coated reinforcement fabric is embedded into rubber; and

FIG. 11 is a schematic of a top view of a pattern coated reinforcement fabric having pattern of dots of varying density across the fabric of tackifing material on surface of the fabric over the adhesion layer.

### DETAILED DESCRIPTION

A frequent problem in making a rubber composite is maintaining good adhesion between the rubber and the reinforcement fabric. A conventional method in promoting the adhesion between the rubber and the reinforcement is to pretreat the reinforcing yarn (before or after formation into a fabric) with an adhesion layer which is typically a mixture of rubber latex and a phenol-formaldehyde condensation product wherein the phenol is almost always resorcinol. This is the so called “RFL” (resorcinol-formaldehyde-latex) method. A patterned coating of a tackifing material on top of the adhesion layer provides for greentack while minimizing the amount of the adhesion layer that is covered up and minimizes the amount of rubber, tackifing material, or other adhesion promoters in the rubber reinforced article.

“Apex” means a non-reinforced elastomer positioned radially above a bead core.

“Axial” and “axially” mean lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Cut belt or cut breaker reinforcing structure” means at least two cut layers of plies of parallel cords, woven or unwoven, underlying the tread, unanchored to the bead, and having both left and right cord angles in the range from 10 degrees to 33 degrees with respect to the equatorial plane of the tire.

“Bias-ply tire” means a tire having a carcass with reinforcing cords in the carcass ply extending diagonally across the tire from bead core to bead core at about a 25°-50° angle with respect to the equatorial plane of the tire. Cords run at opposite angles in alternate layers.

“Cap ply” means a reinforcement structure, typically a woven or knit fabric, located under the tread portion of the tire.

“Circumferential” means lines or directions extending along the perimeter of the surface of the annular tread perpendicular to the axial direction.

“Chafers” refer to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Flipper” means a reinforced fabric wrapped about the bead core and apex.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

The pattern coated reinforcement fabric may be used in any suitable rubber product needing fabric reinforcement. This includes the various textiles used in tires (pneumatic or not), hoses, printer blankets, and belts (such as transmission belts). In one embodiment, the patterned coating of the tackifing material may be used on any suitable fabric for use in a tire. These fabrics include, but are not limited to a body ply (also referred to as a carcass), a bead wrap, a cap ply, a chafer fabric, a clipper fabric, and a flipper fabric.

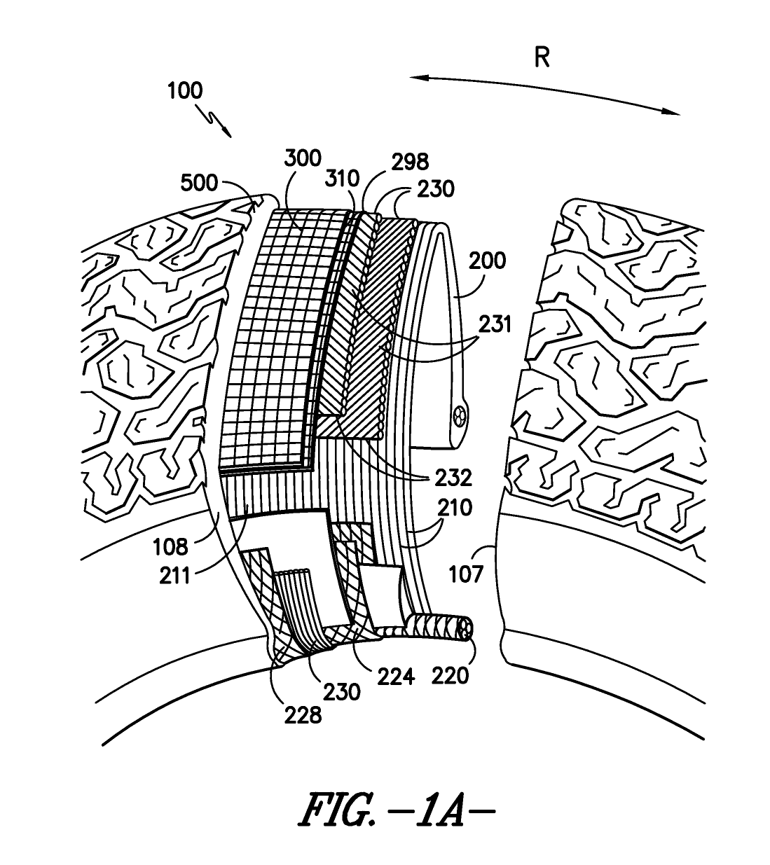

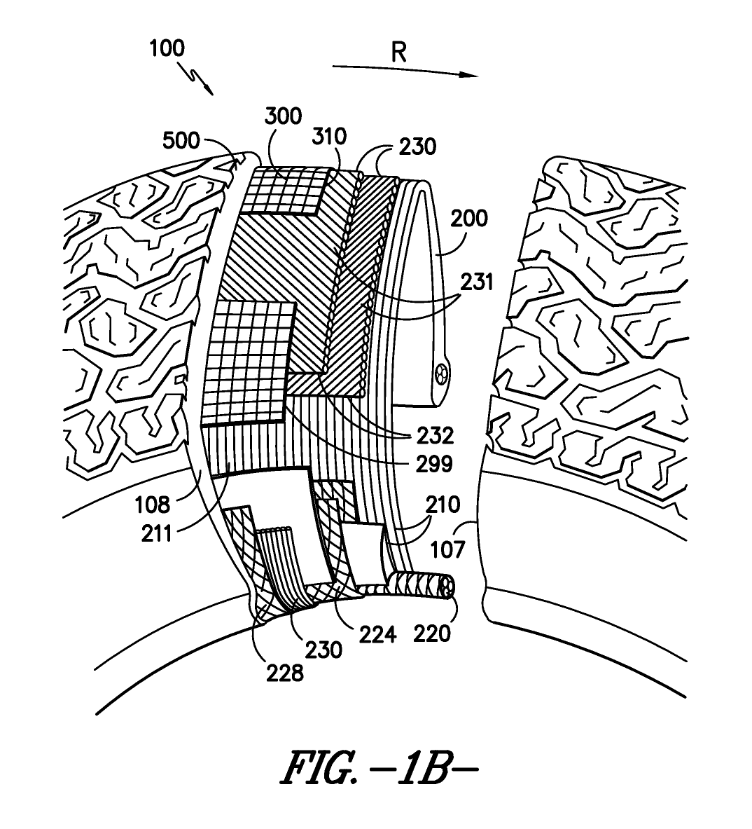

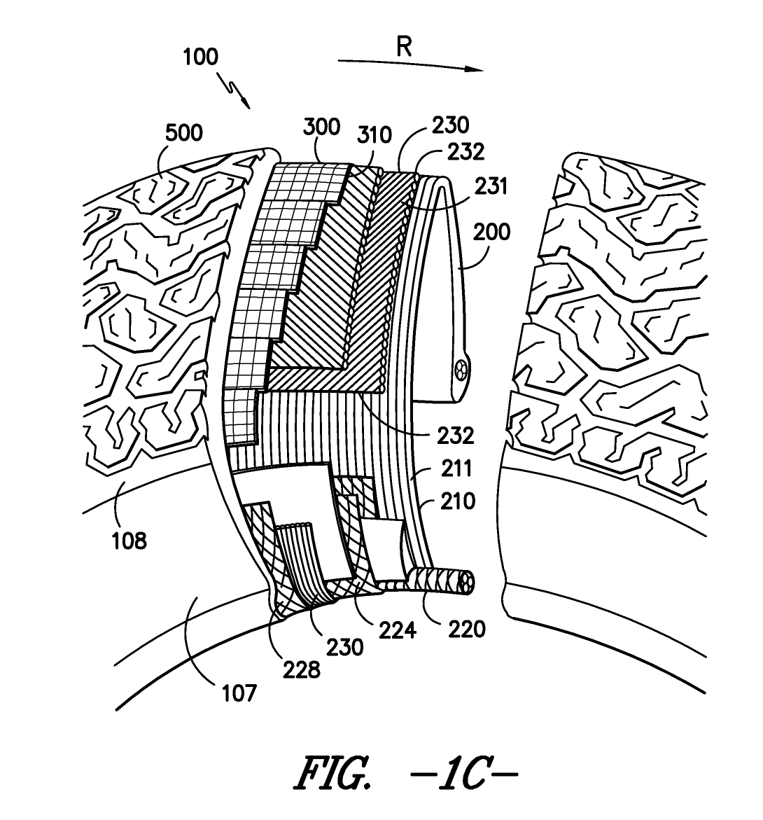

Referring now to the drawings, particular to FIGS. 1A-1C, there is shown a tire 100, comprising side walls 107 joined to a tread 500 by shoulders 108. The tire 100 includes a carcass 200 covered by the tread 500. In FIGS. 1A-1C and 2, the tire 100 is a radial tire. However, the present invention is not limited to radial tires and can also be used with other tire constructions. The carcass 200 is formed from one or more plies of tire cord 210 terminating at the inner periphery of the tire in metal beads 220, with at least one belt ply 230 located circumferentially around the tire cord 210 in the area of the tread 500. In the tire shown in FIGS. 1A-C, the carcass 200 is constructed so that the reinforcing cords 211 are running substantially radially of the intended direction of rotation R of the tire 100. The belt plies 230 are formed with relatively inextensible warp materials 231, such as steel cord reinforcing warps, which run in the intended direction of rotation R of the tire or, more usually, at a slight angle thereto. The angle of the inextensible warp materials 231 can vary with the method of construction or application. The belt plies 230 extend across the width of the tread 500 of the tire terminating in edges 232 in the area of the shoulder 108 of the tire 100, i.e. the area where the tread 500 meets the side wall 107. The bead area consists primarily of the metal beads 220, the flipper 224, the chafer 228, and the tire cord fabric turn up 230.

A cap ply layer 300 (in FIGS. 1A-C) is located between the belt plies 230 and the tread 500. In FIG. 1A, the cap ply layer 300 is formed from a cap ply tape 310 wound around the tire cord 210 in the rolling direction of the tire. In the embodiment illustrated in FIG. 1A, the cap ply tape 310 extends over the edges 232 of the belt plies 230. Additionally, the cap ply tape 310 in FIG. 1A can be wound around the tire cord 210 a plurality of times to reduce the unbalancing effect in the tire 100 caused by the overlap splice. FIG. 1B, the cap ply layer 300 is formed from a cap ply tape 310 which extends over the edge 232 of the belt plies 230. The cap ply layer 300 in FIG. 1C is formed from a cap ply tape 310 which is wound circumferentially around the carcass 200 of the tire 100 in a flat helical pattern. The cap ply tapes 310 in each of the FIGS. 1A-C are made of the same fabric. The width of the cap ply tapes 310 and how it is wrapped varies between the FIGS. 1A-C. FIG. 2 illustrates another view of the tire of FIG. 1C. The cap ply layer may also be any open fabric that helps a tread compound bond with a belt compound.

The chafer fabric 228 is a rubber impregnated fabric, typically in the form of a bias fabric, which is applied to the bead area of the tire in green tire construction. Originally the chafer strip was employed to reduce the chafing effect between the tire and the tire rim and to protect the plies underneath as well as aiding in producing bead shape and firmness in the bead area. In tubeless tires it provides the further function of preventing pressurized air from diffusing through the chafer yarns into the side wall or to the atmosphere causing sidewall blisters and the tire failure, or a flat tire.

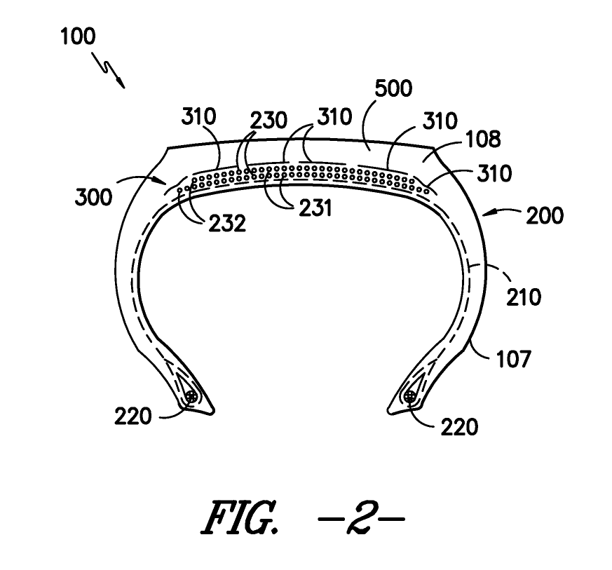

Referring now for FIGS. 3 and 4, there is shown a fabric reinforced hose 600, another example of a fabric reinforced rubber article. One of the most widespread and most suitable conventional hose is the so-called “mesh-reinforced” type, in which the tubular reinforcement fabric 620 is constituted by a yarns spirally wound on the flexible hose forming two sets of yarns, the first in parallel and equidistant rows and superimposed on an equal number of transverse threads along likewise parallel and equidistant lines which are arranged symmetrically with respect to the axis of the tubular body of the hose so as to form a fabric “mesh” with diamond-shaped cells. Any other suitable fabric 620 may also be used in hoses. Typically the inner layer 610 of rubber or plastic is covered by the fabric 620 which is then covered by an outer layer 630 of rubber or plastic. In one embodiment, the reinforcement fabric is arranged in a spirally wound configuration about the tubular body of the hose.

Some other fabric reinforced rubber products include printer blankets and transmission belts. In offset lithography the usual function of a printing blanket is to transfer printing ink from a printing plate to an article such as paper being printed whereby the printing blanket comes into repeated contact with an associated printing plate and the paper being printed. Printer blankets typically include a fabric embedded into rubber. Transmission belts and other types of belts also contain fabric reinforced rubber.

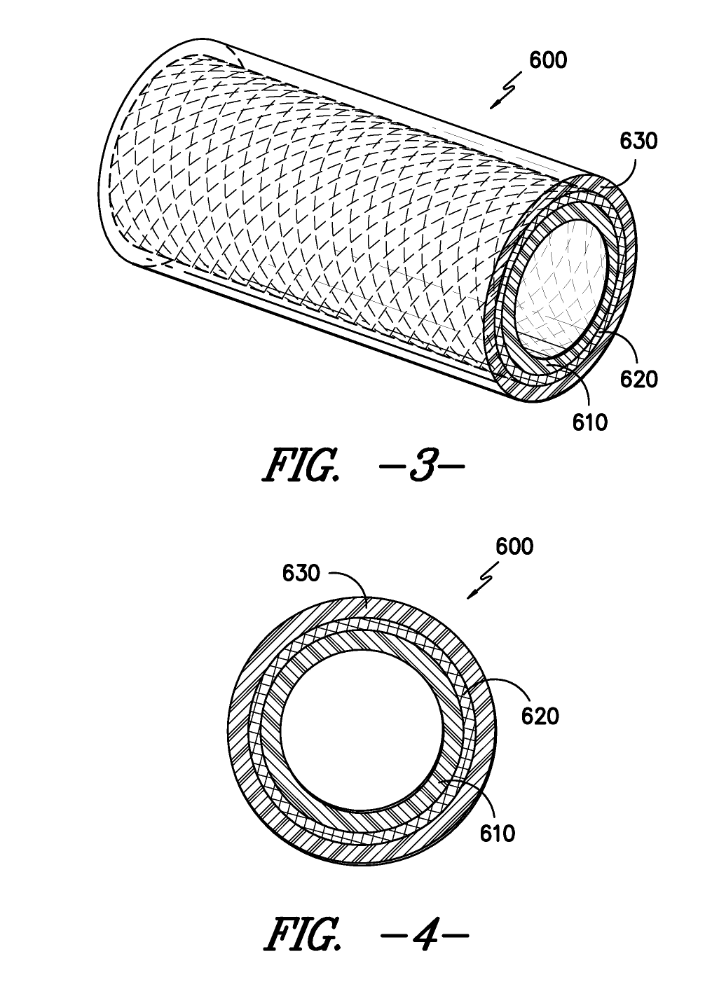

Referring now to FIG. 5, there is shown one embodiment for the pattern coated reinforcement fabric 10. The pattern coated reinforcement fabric 10 comprises a fabric base 20, an adhesion layer 30 on both the first and second sides of the fabric base 20, and a patterned coating 40 of a tackifing material on at least one side of the side overlaying the adhesion layer 30. This pattern coated reinforcement fabric 10 may be used as any of the reinforcement fabrics for any suitable reinforced rubber article such as tires, hoses, printer blankets, and belts previously described.

The fabric base 20 of the pattern coated reinforcement fabric 10 may be any suitable fabric for use in as reinforcement for rubber products. The fabric base 20 may be a woven, non-woven, knit, or unidirectional construction. In one embodiment, the fabric base 20 is a leno woven fabric, such as described in U.S. Pat. No. 7,252,129 by Michiels et al. The fabric base may also be, for example, satin, twill, basket-weave, poplin, jacquard, and crepe weave textiles. Knit textiles for use as the fabric base 20 can include, but are not limited to, circular knit, reverse plaited circular knit, double knit, single jersey knit, two-end fleece knit, three-end fleece knit, terry knit or double loop knit, weft inserted warp knit, warp knit, and warp knit with or without a microdenier face. In one embodiment, the stitching yarns of the knit textile may form stitches along a single warp yarn or may move to adjacent warp yarns as shown in U.S. Pat. No. 7,614,436 by Ternon et al., herein incorporated by reference. In another embodiment, the fabric base 20 is a multi-axial, such as a tri-axial fabric (knit, woven, or non-woven). In another embodiment, the fabric is a bias fabric.

In one embodiment, the fabric base 20 is a non-woven. The term non-woven refers to structures incorporating a mass of yarns that are entangled and/or heat fused so as to provide a coordinated structure with a degree of internal coherency. Non-woven fabrics for use as the fabric bases 20 may be formed from many processes such as for example, meltspun processes, hydroentangeling processes, mechanically entangled processes, stitch-bonded and the like. A unidirectional textile for use as the fabric base 20 may have overlapping yarns or there may be gaps between the yarns.

Preferably, the fabric base 20 has an open enough construction to allow subsequent coatings to pass through the fabric base 20 minimizing window pane formation.

In one embodiment, the fabric base 20 is a plain weave fabric which is also typically used as tire cord in tire construction. This plain weave fabric is typically made of nylon yarns in the warp and weft directions, though other yarns may be used. In one specific example, the yarns used are nylon 6,6 with a 940 detex and 1 ply. Any desired construction may be used, with one embodiment having with between 100 and 150 ends per decimeter and about 10-15 warps per decimeter. The yarns may have any level of twisting, which in one embodiment preferably is about 110 twists per meter. The fabric may be cut to any desired width, which in one application is approximately 10 mm.

In the embodiments where the fabric base 20 is a knit or woven, the construction preferably can have from 2 up to 28 ends per inch (0.7 to 11 ends per centimeter). Number of ends is defined as the number of wales or the number of needles (or gauge) on a fabric or the number of warp yarns 312 per cm (or per inch). In one embodiment, there are between 2 and 40 stitches (of the stitching yarn 311) per inch (0.8 and 16 stitches per cm).

The yarns of the fabric base 20 can be any suitable yarn, including but not limited to a spun staple yarn, a multifilament yarn, and/or a monofilament yarn and are formed of a material which will restrain the belt plies 230. “Yarn”, in this application, as used herein includes a monofilament elongated body, a multifilament elongated body, ribbon, strip, fiber, tape, and the like. The term yarn includes a plurality of any one or combination of the above. Some suitable materials for the yarns include polyamide, aramides (including meta and para forms), rayon, PVA (polyvinyl alcohol), polyester, polyolefin, polyvinyl, nylon (including nylon 6, nylon 6,6, and nylon 4,6), polyethylene naphthalate (PEN), cotton, steel, carbon, fiberglass, steel, polyacrylic or any other suitable artificial or natural fiber. In one embodiment, the yarns may be single monofilament or multifilaments yarns (twisted and/or cabled cords) made with any of the prior listed materials, also including hybrid yarns, or film-tape yarns. In one embodiment for some tire fabrics, the yarns used in the “warp direction” should be between 100 decitex (90 deniers) up to 23,500 decitex (21,000 deniers) made with single or multiple yarns (for example, 235 decitex (single end) or 235 decitex×2×3 plies equals 1,410 decitex or 1,100 decitex×3×3 plies equal to 9,900 decitex (multiple ends)).

In one embodiment, the yarns used in the fabric base 20 may be hybrid yarns. These hybrid yarns are made up of at least 2 fibers of different fiber material (for example, cotton and nylon). These different fiber materials can produce hybrid yarns with different chemical and physical properties. Hybrid yarns are able to change the physical properties of the final product they are used in. Some preferred hybrid yarns include an aramide fiber with a nylon fiber, an aramide fiber with a rayon fiber, and an aramide fiber with a polyester fiber.

A frequent problem in making a rubber composite is maintaining good adhesion between the rubber and the reinforcement. A conventional method in promoting the adhesion between the rubber and the reinforcement is to pretreat the reinforcing yarn with an adhesion layer typically formed from a mixture of rubber latex and a phenol-formaldehyde condensation product wherein the phenol is almost always resorcinol. This is the so called “RFL” (resorcinol-formaldehyde-latex) method.

In the pattern coated reinforcement fabric 10, the fabric base 20 is coated with the adhesion layer 30 by a conventional method. Preferably, the adhesion layer is a resorcinol formaldehyde latex (RFL) layer. Generally, the adhesion layer 30 is applied by dipping the fabric base 20 or yarns (before formation into fabric) in a RFL solution. The coated fabric or yarns then pass through squeeze rolls and a drier to remove excess liquid. The adhesion layer 30 is typically cured at a temperature in the range of 150° to 200° C. The resorcinol-formaldehyde latex can contain vinyl pyridine latexes, styrene butadiene latexes, waxes, fillers and/or other additives. The adhesion layer 30 is typically on both sides of the fabric base 20 and preferably coats all or almost all available surface of the yarns within the fabric base 20.

The pattern coated reinforcement fabric 10 further contains a patterned coating 40 of a tackifing material on at least one side of the fabric base 20 on top of the adhesion layer 30. The patterned coating 40 may be on one or both sides of the fabric base 20 over the adhesion layer 30. The first side and the second side of the fabric base 20 may contain the same pattern or different patterns. In one embodiment, the tackifing material is placed a first side of the fabric base 20 (over the adhesion layer 30) in a patterned coating and on the second side, the tackifing material may be placed as a continuous non-patterned coating. Typical examples of tackifing material include mixtures containing resorcinol formaldehyde latex (RFL), isocyanate based material, epoxy based material, rubber, PVC, and materials based on melamine formaldehyde resin.

These tackifing materials serve to promote adhesion between the fabric base 20 (with the adhesion layer 30) and the rubber during manufacture. For tire manufacturing, this tackifing material promotes adhesion in a green tire, before curing.

The tackifing materials serve to form a tackified finish for facilitating adhesion, or green tack, during the building process of a green tire, hose, or other rubber reinforced products. The tackifing materials serve to promote adhesion between the fabric base 20 (with the adhesion layer 30) and the rubber during manufacture. The selection of materials for the tackified finish will depend greatly upon the materials selected for use in the reinforced rubber product. In prior art, the entire fabric base (such as a cap ply layer) surface was completely covered in a cement coating of rubber or with a different adhesion promoting or tackifing chemistry. In a tire product, it is desirable to reduce the amount of rubber between the layers as the excess rubber absorbs energy from the running tire and causes early wear and failure.

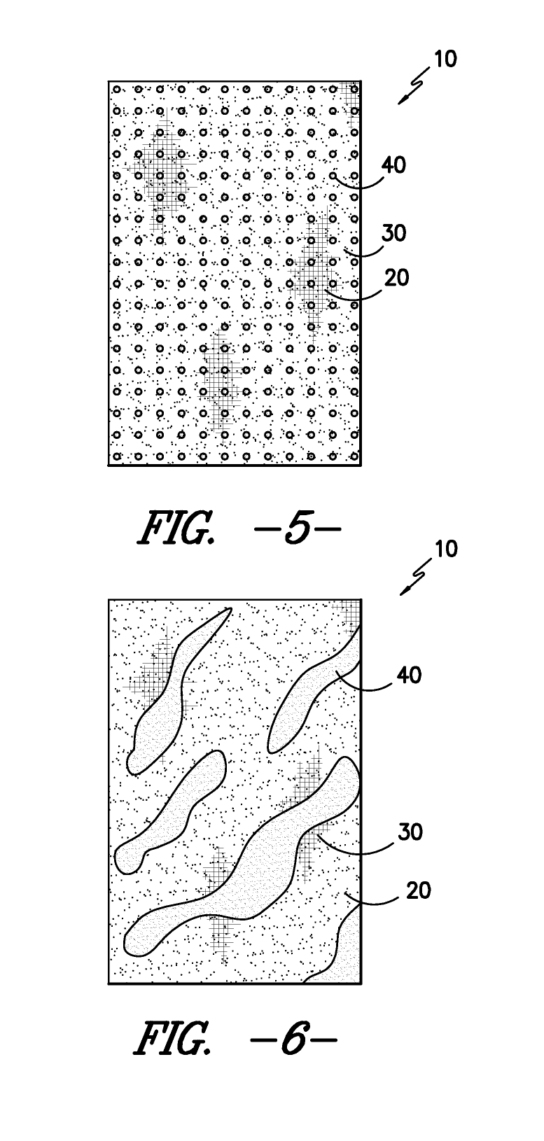

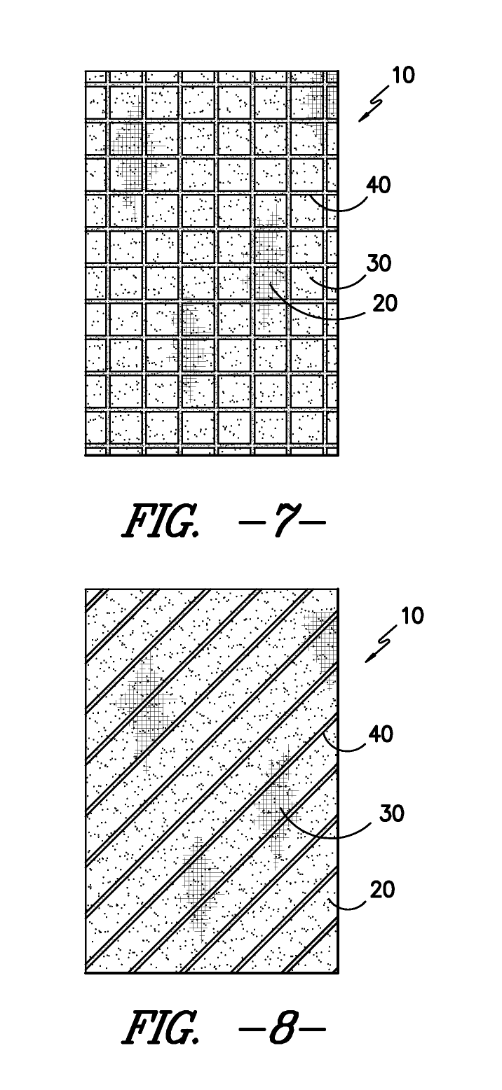

Having the tackifing material in a patterned coating 40 provides for greentack while minimizing the amount of the surface area of the adhesion layer that is covered up and minimizes the amount of rubber and tackifing agents in the tire, hose, or other fabric reinforced rubber products. The patterned coating 40 may be continuous or discontinuous, regular and repeating or random. “Continuous” in this application means that from one edge of the fabric to the other edge there is at least one continuous path that contains the patterned coating and that at least some of the patterned coating areas are connected. Examples of continuous coatings include FIGS. 7 and 8. “Discontinuous” in this application means that the pattern coated areas are discontinuous and not touching one another. In a discontinuous patterned coating, there is no path from one edge of the fabric to the other that contains the patterned coating. Examples of discontinuous coatings include FIGS. 5 and 6. Regular or repeating patterns mean that the pattern has a repeating structure to it. FIGS. 5, 7 and 8 illustrate repeating or regular patterns. FIG. 6 illustrates a random pattern where there is no repeat to the patterned coating. In a random pattern, it is preferred that the random pattern is also discontinuous, not continuous. While the patterned coating 327 is shown as applied to the fabric, a patterned coating of tackifing material may also be applied to the yarns before fabric formation.

FIG. 5 illustrates the embodiment where the patterned coating is in a dot pattern. This pattern is discontinuous and repeating. The dots may be equally spaced on the fabric base 20 over the adhesion layer 30, or may have differing densities or frequencies of dots, sizing of dots, or size and/or shape of dots across the surface of the fabric. FIG. 6 illustrates the embodiment where the patterned coating 40 is in random, discontinuous spot pattern. FIG. 7 illustrates the embodiment where the patterned coating 40 is in a grid. This pattern is regular and continuous. FIG. 11 illustrates the embodiment where the patterned coating 40 is in a series of parallel lines. This pattern is also regular and continuous. The patterned coating 40 may take any other patterned form including but not limited to indicia, geometric shapes or patterns, and text.

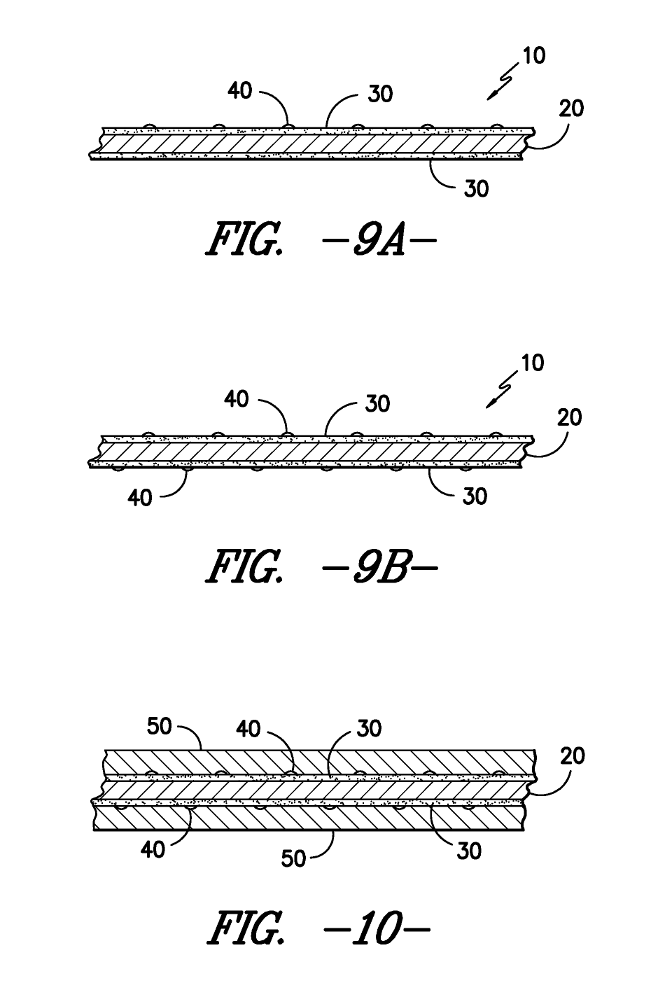

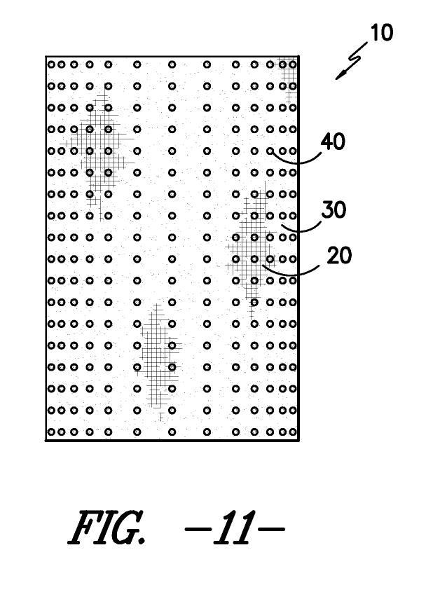

FIGS. 9A and 9B illustrate side views of the pattern coated reinforcement fabric 10 illustrating the patterned coating 40 on one side of the pattern coated reinforcement fabric 10 (9A) and both sides of the pattern coated reinforcement fabric 10 (9B). The patterned coatings may be the same or different patterns and coverage on both sides of fabric base 20 (over the adhesion layer 30). For example, one side of the fabric base may have a regular repeating grid pattern covering 10% of the surface area and the other side of the cap ply may have a discontinuous repeating dot pattern covering 25% of the surface. Each surface pattern may be chosen to optimize the tire production process and article. FIG. 10 illustrates the pattern coated reinforcement fabric 10 embedded into rubber 50. Preferably, the rubber 50 migrates or impregnates partially or fully the fabric base 10.

In one embodiment, the patterned coating 40 of tackifing material is on the cross-over points in the fabric, for example where the weft and warp yarns cross in a woven fabric. In another embodiment, the patterned coating 40 of tackifing material is substantially only on the cross-over points in the fabric and not on the rest of the fabric base 20. This may help eliminate or reduce window pane formation from occurring (where the coating forms a film in the open areas of the fabric).

The patterned coating 40 may be formed by any known method of forming a patterned coating including but not limited to inkjet printing, gravure printing, patterned printing, thermal transfer, spray coating, and silk printing. The thickness and/or physical composition of the patterned coating 40 may vary over the length and/or width of the pattern coated reinforcement fabric 10. For example, it may be preferred in some embodiments to have a thicker coating or more densely packed pattern in some areas of the cap ply. This can be seen, for example, in FIG. 11 where the dot pattern of the patterned coating layer varies over the width of the cap ply to have a higher amount of patterned coating on the edges of the cap ply.

In one embodiment, the patterned coating covers between about 5 and 95% of the surface area of the pattern coated reinforcement fabric 10. In other embodiments, the patterned coating may cover between about 5 and 70%, 10 and 60%, 45 and 75%, greater than 15%, greater than 20% and greater than 30% of the surface area of the pattern coated reinforcement fabric 10. In another embodiment, the patterned coating 40 has a weight of between about 5 and 60% wt of the pattern coated reinforcement fabric 10. In other embodiments, the patterned coating has a weight of between about 5 and 50%, 10 and 50%, 10 and 45%, 15 and 35%, greater than 15%, greater than 20% and greater than 30% of the weight of the pattern coated reinforcement fabric 10.

The formation of a pattern coated reinforcement fabric 10, such as a cap ply tape 310, begins with the acquisition of the basic yarns for the fabric. Subsequently, the yarns may be twisted to provide additional mechanical resilience. After the twisting, the fabric is formed in large widths, such as 61.4 inches. After the fabric formation, the fabric is finished with an adhesion layer (typically an RFL coating) before or after slitting. Next, a patterned coating is applied to the fabric base 20 over the adhesion layer on at least one side. In another embodiment, the yarns are coated with an adhesion layer (typically an RFL coating) and then treated with an tackifing material in a discontinuous manner before the fabric base is formed. In another embodiment, the yarns are coated with an adhesion layer (typically an RFL coating), then formed into a fabric base, and then treated with an tackifing material in a discontinuous manner. The final fabric may be slit into desired widths for placement on a spool.

For the pattern coated cap ply reinforcement embodiment shown in FIG. 1A, the cap ply tape 310 is located edge to edge as it is laid on the carcass 200 of the tire 100, and is wrapped around the entire belt ply 230 area of the tire 100. In the embodiment shown in FIG. 1B, two pieces of the cap ply tape 310 are wrapped around the carcass 200 of the tire 100 such that the cap ply layer 300 extends beyond the edges 232 of the belt plies 230, under the shoulder 108 area of the tire 100. Overlapping the edge 232 of the belt 230 with the cap ply tape 310 provides support to the edges 232 of the belt 230 where excessive temperature can build up. For the embodiment shown in FIG. 1C, the cap ply tape 310 is constructed with a width preferably of about 5 mm to 25 mm. More preferably, the cap ply tape 310 is constructed with a width of about 8 mm to 15 mm. The width of the cap ply tape 310 affects the ability to form a uniform flat layer of the cap ply tape 310 across the surface of the carcass 200 of the tire 100. In the helical wrapping process, wider strips will cause buckles on the leading edge of the wrap due to excessive width of the materials. Shorter widths provide difficulties in manufacturing the tire 100 due to an excessive number of revolutions necessary in the wrapping procedure to achieve the desired coverage of the carcass 200 with the cap ply tape 310.

In the case where the reinforcement fabric 10 is a cap ply 310, the warp yarns wrap around the carcass 200 due to the wrapping of the cap ply tape 310 around the carcass 200. It is the warp yarns in the fabric base 20 that provide most of the reinforcement of the cap ply layer 300. The construction, material, size, and spacing of all of the yarns are selected such that they provide the desired strength of the cap ply layer 300 to prevent the belt ply 230 from moving outward in the tire 100 and to protect the rubber in the tire 100 from sharp portions of the belt plies 230.

Also in the embodiment shown in FIG. 1C, the cap ply tape 310 permits the strike through of the rubber in the tire 100 for a better bonded construction. The flat helical pattern typically will need more than three full revolutions of the cap ply tape 310 around the carcass 200 of the tire 100. The length of cap ply tape 310 will depend on the diameter of the tire 100, the width of the cap ply tape 310, and the amount of coverage provided by the cap ply tape 310. The approximate minimum length of a cap ply tape 310 in a cap ply layer 300, with only one layer of cap ply tape 310 and no gaps or over lapping regions, can be calculated according to the following formula:

length=2πrw/t

where π is 3.14, r is the radius of the tire, w is the width of the area of the tire to be covered, and t is the width of the tape. As an example, for a 185/60/R14 tire, the length of a 13 mm wide cap ply tape 310 would be a minimum of about 15 linear meters in length, and can have an additional amount of about 2-3 meters for overlapping itself in the shoulder area. Greater strength can be built into the cap ply tape 310 by constructing the cap ply tape 310 such that the warp yarns in the cap ply tape 310, run longitudinally for the length of tape as continuous uncut yarns. Cross-winding the cap ply tape 310 across a cardboard tube provides a convenient package for subsequent removal of the cap ply tape 310 in the manufacturing process of tire 100.

The cap ply layer 300, shown in FIGS. 1A-C, can comprises multiple layers, e.g. two, three, or even more layers, of the cap ply tape 310 that are wound over the ply layer 230 of the carcass 200 to provide extra strength. In one embodiment, the cap ply tape 310 is laid into a double layer in the shoulder 108 area of the tire 100, providing additional strength at the edges 232 of the belt 230. In another embodiment, the cap ply 300 can have two layers of cap ply tape 310 securing the belt ply 230 across the width of the tire 100. When more than one layer of cap ply tape 310 is used for the cap ply 300, a layer of unvulcanized rubber is placed between the layers of cap ply tape 310 to insure a good bond. Also, in an embodiment where multiple layers of the cap ply tape 310 are used, the layers of cap ply tape 310 can be staggered so that upper strips of cap ply tape 310 cover the edges of the cap ply tape 310 in the lower layer.

The cap ply layer 300 of the present invention can be used with one belt ply, two belt plies (as illustrated in FIGS. 1A-1C and 2), or more than two belt plies below the cap ply layer 300. In an alternate embodiment of the present invention the tire can have multiple belt plies with cap ply layers, disposed over each belt ply layer creating alternating layers of belt plies and cap plies. In the alternate embodiment, the cap ply layer can also overlap the edge of the underlying belt ply, and/or have multiple layers of cap ply tape (which can also be staggered so that upper strips overlap edges on lower strips).

In the tire formation process, the tire carcass 200 is formed with the tire cord 210, metal beads 220, and belt plies 230. After the tire carcass 200 is formed (and is tire shaped), the cap ply tape 310 is wound from the package around the belt plies 230 to form the cap ply layer 300. After the cap ply layer 300 is placed on the tire carcass 200, the tread 500 is molded onto the subassembly, and the tire 100 is completed. Alternatively, the cap ply tape 310 may be wrapped into the diameter of the finished tire and may or may not have additional layers applied to it, such as tread. Then the tire is formed from a flat shape expanded and shaped into a tire shape to meet up with the ring of fabric tape and the two are joined together.

What is claimed is:

1. A fabric reinforced rubber article comprising at least one layer of a pattern coated reinforcement fabric embedded in rubber, wherein the pattern coated reinforcement fabric comprises:
a fabric base having a first and second side, wherein the fabric base is selected from the group consisting of woven, knit, and nonwoven;
an adhesion layer on both the first and second side of the fabric base; and,
a patterned coating of a tackifing material on at least the first side of the fabric base overlaying a portion of the adhesion layer.

2. The fabric reinforced rubber article of claim 1, wherein the adhesion layer comprises resorcinol formaldehyde latex (RFL).

3. The fabric reinforced rubber article of claim 1, wherein the rubber is at least partially impregnated through the fabric base.

4. The fabric reinforced rubber article of claim 1, wherein the patterned coating is discontinuous.

5. The fabric reinforced rubber article of claim 1, wherein the patterned coating is continuous.

6. The fabric reinforced rubber article of claim 1, wherein the patterned coating is repeating.

7. The fabric reinforced rubber article of claim 1, wherein the patterned coating is random.

8. The fabric reinforced rubber article of claim 1, wherein the patterned coating has a pattern selected from the group consisting of lines, a grid of lines, discontinuous dots, and indicia.

9. The fabric reinforced rubber article of claim 1, wherein the tackifing material is selected from the group consisting of resorcinol formaldehyde latex (RFL), isocyanate based material, epoxy based material, melamine formaldehyde resin, and natural or synthetic rubber.

10. The fabric reinforced rubber article of claim 1, wherein the fabric reinforced rubber article is a printers blanket.

11. The fabric reinforced rubber article of claim 1, wherein the fabric reinforced rubber article is a belt.

12. A fabric reinforced tire comprising at least one layer of a pattern coated reinforcement fabric embedded in rubber, wherein the pattern coated reinforcement fabric comprises:
a fabric base having a first and second side, wherein the fabric base is selected from the group consisting of woven, knit, and nonwoven;
an adhesion layer on both the first and second side of the fabric base; and,
a patterned coating of a tackifing material on at least the first side of the fabric base overlaying a portion of the adhesion layer.

13. The fabric reinforced rubber article of claim 12, wherein the adhesion layer comprises resorcinol formaldehyde latex (RFL).

14. The fabric reinforced tire of claim 12, wherein the pattern coated reinforcement fabric forms the reinforcement fabric for tires selected from the group consisting of a cap ply fabric, a carcass fabric, a chafer fabric, a bead wrap fabric, a belt ply fabric, and a flipper fabric.

15. The fabric reinforced tire of claim 12, wherein the rubber is at least partially impregnated through the fabric base.

16. The fabric reinforced tire of claim 12, wherein the patterned coating is discontinuous.

17. The fabric reinforced tire of claim 12, wherein the patterned coating is continuous.

18. The fabric reinforced tire of claim 12, wherein the patterned coating is repeating.

19. The fabric reinforced tire of claim 12, wherein the patterned coating is random.

20. The fabric reinforced tire carcass of claim 12, wherein the patterned coating has a pattern selected from the group consisting of lines, a grid of lines, discontinuous dots, and indicia.

21. The fabric reinforced tire of claim 12, wherein the patterned coating covers a portion of both of the sides of the fabric.

22. A fabric reinforced rubber hose comprising a tubular body of flexible rubber and at least one layer of a pattern coated reinforcement fabric embedded in the flexible rubber, wherein the pattern coated reinforcement fabric comprises:
a fabric base having a first and second side, wherein the fabric base is selected from the group consisting of woven, knit, and nonwoven;
an adhesion layer on both the first and second side of the fabric base; and,
a patterned coating of a tackifing material on at least the first side of the fabric base overlaying a portion of the adhesion layer.

23. The fabric reinforced rubber article of claim 22, wherein the adhesion layer comprises resorcinol formaldehyde latex (RFL).

24. The fabric reinforced rubber hose of claim 22, wherein the rubber is at least partially impregnated through the fabric base.

25. The fabric reinforced rubber hose of claim 22, wherein the pattern coated reinforcement fabric is arranged in a spirally wound configuration about the tubular body.

26. The fabric reinforced rubber hose of claim 22, wherein the fabric base comprises two sets of yarns, the first set of yarns comprising parallel, equidistantly spaced apart yarns superimposed on the second set of yarns, where the second set of yarns comprise parallel, equidistantly spaced apart yarns arranged symmetrically with the first set of yarns with respect to the longitudinal axis of the tubular body.

27. The fabric reinforced rubber hose of claim 22, wherein the patterned coating is discontinuous.

28. The fabric reinforced rubber hose of claim 22, wherein the patterned coating is continuous.

29. The fabric reinforced rubber hose of claim 22, wherein the patterned coating is repeating.

30. The fabric reinforced rubber hose of claim 22, wherein the patterned coating has a pattern selected from the group consisting of lines, a grid of lines, discontinuous dots, and indicia.

31. The fabric reinforced rubber hose of claim 22, wherein the patterned coating covers a portion of both of the sides of the fabric base.
